(19) United States
(12) Patent Application Publication
(10) Pub. No.: US 2025/0180747 A1
(43) Pub. Date: Jun. 5, 2025

(54) TIME-OF-FLIGHT SENSING SYSTEM AND TIME-OF-FLIGHT SENSING METHOD

(71) Applicant: HIMAX TECHNOLOGIES LIMITED, Tainan City (TW)

(72) Inventors: Wu-Feng Chen, Tainan City (TW); Hsueh-Tsung Lu, Tainan City (TW)

(73) Assignee: HIMAX TECHNOLOGIES LIMITED, Tainan City (TW)

(21) Appl. No.: 18/527,334

(22) Filed: Dec. 3, 2023

(51) Int. Cl. G01S 17/894; G01B 11/22; G01S 7/481

(52) U.S. Cl. CPC G01S 17/894; G01B 11/22; G01S 7/4817

(57) ABSTRACT

A time-of-flight sensing system including a laser scanning module, a sensing device and a control circuit is provided. The laser scanning module is configured to sequentially and respectively provide a plurality of first laser beams to a plurality of first sub-areas of a sensing target. The sensing device is configured to receive the first laser beams respectively reflected from the first sub-areas of the sensing target. The control circuit is electrically coupled to the laser scanning module and the sensing device, and is configured to calculate first depth signals of the first sub-areas of the sensing target according to the first laser beams sequentially and respectively reflected from the first sub-areas of the sensing target and received by the sensing device. A time-of-flight sensing method is also provided.

### BACKGROUND

### Technical Field

This disclosure relates to a sensing technology, and in particularly, relates to a time-of-flight sensing system and a time-of-flight sensing method.

### Description of Related Art

With the rise of computer vision applications in various industries, various three-dimensional (3D) depth sensing technologies are booming. For example, a time-of-flight (ToF) ranging device is used in the general application of 3D depth sensing technology. Due to the high detection rate, small module size, low cost and high depth spatial resolution, an indirect time-of-flight (iToF) 3D depth sensing technology is widely used in fields such as robot vision and autonomous driving.

In general, a flood illuminator is used in the iToF 3D depth sensing device to provide flood light to a target object. However, when the target object has multiple planes facing each other, a part of the flood light will be multiple reflected in these planes. The multiple reflected light will interfere with the one-time reflected light from the target area, which means the sensor of the iToF 3D depth sensing device will suffer the multipath interference (MPI) issue and cause a false depth signal.

### SUMMARY

In view of the foregoing problems, the disclosure provides a time-of-flight sensing system and a time-of-flight sensing method capable of improving the accuracy of measured depth or distance.

The disclosure provides a time-of-flight sensing system including a laser scanning module, a sensing device and a control circuit. The laser scanning module is configured to sequentially and respectively provide a plurality of first laser beams to a plurality of first sub-areas of a sensing target. The sensing device is configured to receive the first laser beams respectively reflected from the first sub-areas of the sensing target. The control circuit is electrically coupled to the laser scanning module and the sensing device, and is configured to calculate first depth signals of the first sub-areas of the sensing target according to the first laser beams sequentially and respectively reflected from the first sub-areas of the sensing target and received by the sensing device.

The disclosure further provides a time-of-flight sensing method including the following steps: providing a plurality of first laser beams to a plurality of first sub-areas of a sensing target sequentially and respectively, receiving the first laser beams respectively reflected from the first sub-areas of the sensing target by a sensing device, and calculating first depth signals of the first sub-areas of the sensing target according to the first laser beams sequentially and respectively reflected from the first sub-areas of the sensing target and received by the sensing device.

Based on the above, in the time-of-flight sensing system and the time-of-flight sensing method according to an embodiment of the disclosure, a laser scanning module is adopted to provide a plurality of first laser beams. The first laser beams are sequentially and respectively transmitted to a plurality of first sub-areas of a sensing target. Since the laser scanning module is provided with high directivity, the possibility of receiving multiple reflected laser beam is significantly reduced when the sensing device is receiving the first laser beam reflected from one of the first sub-areas. Such that, the signal-to-noise ratio of the received signal may be improved and a more accurate depth signal may be provided by the time-of-flight sensing system.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a time-of-flight sensing system according to a first embodiment of the disclosure.

FIG. 2 is a schematic diagram of the laser scanning module in FIG. 1.

FIG. 3 is a schematic front-view of the sensing target in FIG. 1.

FIG. 4 is a schematic waveform of a first laser beam and the first laser beam reflected from the sensing target in FIG. 1.

FIG. 5 is a flow chart of a time-of-flight sensing method according to a first embodiment of the disclosure.

FIG. 6 is a schematic diagram of a laser scanning module according to another embodiment of the disclosure.

FIG. 7 is a schematic front-view of the sensing target irradiated by an expanded first laser beam provided by the laser scanning module in FIG. 6.

FIG. 8 is a flow chart of a time-of-flight sensing method according to another embodiment of the disclosure.

FIG. 9 is a schematic front-view of the sensing target simultaneously irradiated by multiple laser beams.

FIG. 10 is a flow chart of a time-of-flight sensing method according to still another embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

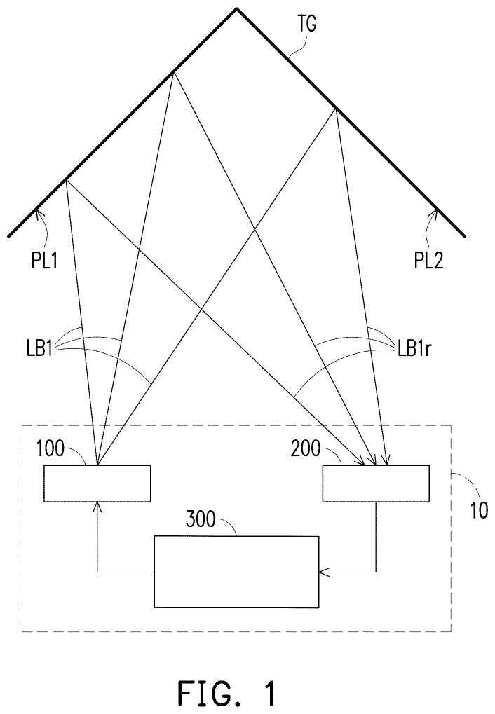

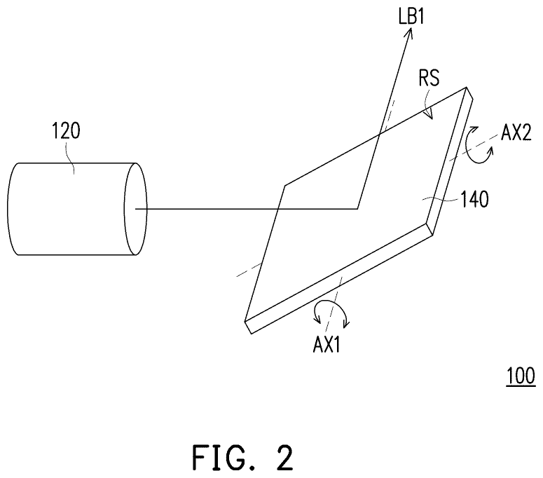

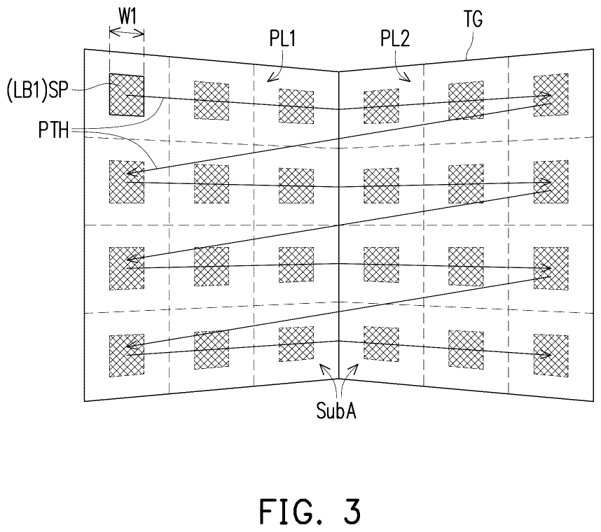

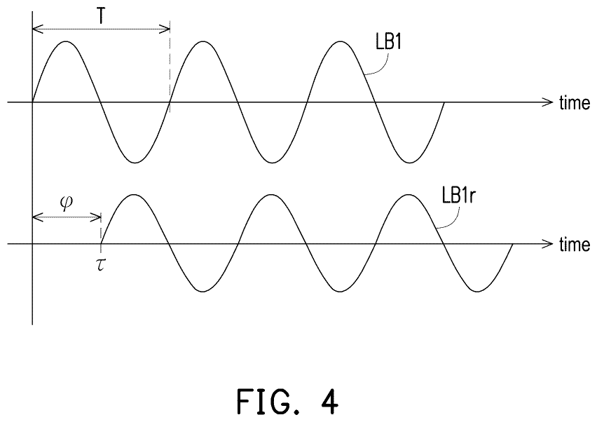

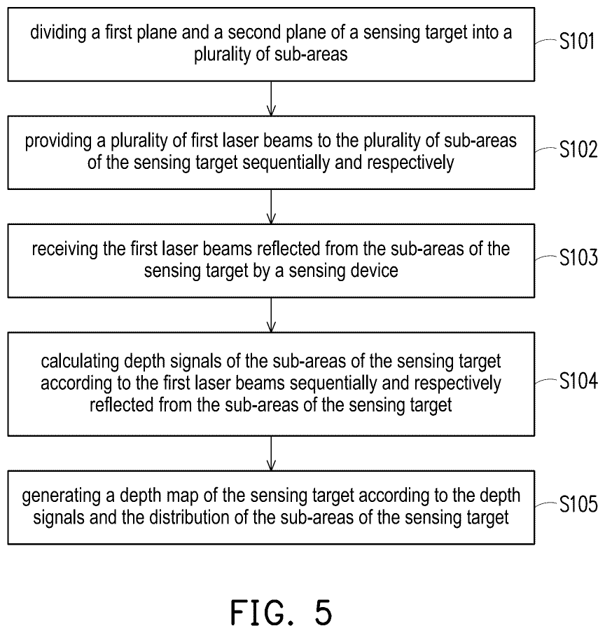

FIG. 1 is a schematic diagram of a time-of-flight sensing system according to a first embodiment of the disclosure. FIG. 2 is a schematic diagram of the laser scanning module in FIG. 1. FIG. 3 is a schematic front-view of the sensing target in FIG. 1. FIG. 4 is a schematic waveform of a first laser beam and the first laser beam reflected from the sensing target in FIG. 1. FIG. 5 is a flow chart of a time-of-flight sensing method according to a first embodiment of the disclosure.

Referring to FIG. 1 and FIG. 2, a time-of-flight sensing system 10 includes a laser scanning module 100, a sensing device 200 and a control circuit 300. The control circuit 300 is electrically coupled to the laser scanning module 100 and the sensing device 200. The laser scanning module 100 is configured to provide a plurality of first laser beams LB1 toward a sensing target TG. The laser scanning module 100 may includes a light source 120 and a scanning mirror 140. The light source 120 may be a solid-state laser and emit a collimated laser beam (i.e. the first laser beam LB1). The scanning mirror 140 is disposed on an optical path of the collimated laser beam, and is suitable for directing the collimated laser beam to the desired position or direction.

For example, the scanning mirror 140 may be a MEMS (micro-electro-mechanical systems) scanning mirror, and a reflective surface RS of the scanning mirror 140 is suitable for swinging about a rotating axis AX1 or/and a rotating axis AX2, but the disclosure is not limited thereto. The normal direction of the reflective surface RS changes over time to reflect the collimated laser beam toward the sensing target TG in a scanning manner.

Referring to FIG. 1 and FIG. 3, the sensing target TG may be any object in different usage scenarios, for example, a house, walls, a car, furniture, or a creature, but the disclosure is not limited thereto. In the present embodiment, the sensing target TG may be a wall structure having a first plane PL1 and a second plane PL2 facing each other and intersecting each other.

In the present embodiment, the first plane PL1 and the second plane PL2 may be divided into a plurality of sub-areas SubA by the control circuit 300, but the disclosure is not limited thereto. In other embodiment, the number of divided sub-areas can be adjusted according to actual needs.

It should be noted that the first laser beams LB1 are respectively and sequentially transmitted to and illuminate the plurality of sub-areas SubA. For example, the sub-areas SubA may be sequentially irradiated by the first laser beam LB1 in a zig-zag manner (see the scan path PTH illustrated in FIG. 3), but the disclosure is not limited thereto. In the present embodiment, the contour of the beam spot SP on the surface of the sensing target TG may be square or rectangular, but the disclosure is not limited thereto. In other embodiment, the contour of the beam spot on the surface of the sensing target TG may be circular or other appropriate shape.

On the other hand, the sensing device 200 is configured to receive the first laser beams LB1 respectively and sequentially reflected from the first sub-areas of the sensing target TG, i.e. the reflected first laser beams LB1r. The sensing device 200 may include a plurality of sensing pixels (not illustrated), and the sensing pixel may be, for example, a complementary metal-oxide-semiconductor (CMOS) image sensor, but the disclosure is not limited thereto. The sensing pixel is designed to receive the reflected first laser beam LB1r and converts the photonic energy to electrical current.

The control circuit 300 is configured to calculate depth signals of the sub-areas SubA of the sensing target TG according to the electrical current generated by the sensing device 200 after receiving the reflected first laser beams LB1r (i.e. the first laser beams LB1 respectively and sequentially reflected from the sub-areas SubA of the sensing target TG). The control circuit 300 is also configured to generate a depth map of the sensing target TG according to the depth signals and the distribution of the sub-areas SubA of the sensing target TG.

In the present embodiment, the first laser beams LB1 emitted from the laser scanning module 100 may be modulated continuous waves (as illustrated in FIG. 4). More specifically, the first laser beam LB1 may be a sinusoidal wave, but the disclosure is not limited thereto. In another embodiment, the laser beam provided by the laser scanning module may be a square wave.

Referring to FIG. 1 and FIG. 4, the phase shift φ between the first laser beam LB1 and the reflected first laser beam LB1r is measured and translated to a distance d (or depth) between the sensing target TG and the time-of-flight sensing system 10. In detail, the phase shift q and the distance d satisfy the following equations: T=φT/(2π) and d=τc/2, wherein t is the delay time of the reflected first laser beam LB1r relative to the first laser beam LB1 in a time sequence, T is the period of the sinusoidal wave, and c is speed of light.

In the present embodiment, the sensing target TG is an object having two surfaces facing each other. It is easy for light to be multiple reflected in these two surfaces. Since the laser scanning module 100 is provided with high directivity, i.e. the first laser beam LB1 is collimated, the possibility of receiving multiple reflected laser beam is significantly reduced when the sensing device 200 is receiving the reflected first laser beam LB1r from one of the sub-areas SubA. Such that, the signal-to-noise ratio of the received signal may be improved and thus a more accurate depth signal is provided by the time-of-flight sensing system 10.

The following will exemplarily describe a sensing method of the time-of-flight sensing system 10. Referring to FIG. 1, FIG. 3 and FIG. 5, Firstly, dividing the first plane PL1 and the second plane PL2 of the sensing target TG into a plurality of sub-areas SubA (as illustrated in FIG. 3), i.e. step S101. Then, providing a plurality of first laser beams LB1 to the plurality of sub-areas SubA of the sensing target TG sequentially and respectively, i.e. step S102. In the present embodiment, the plurality of first laser beams LB1 are respectively irradiated on the plurality of sub-areas SubA along the scan path PTH in a time sequence.

After any one of the first laser beams LB1 reflecting off the surface of the first plane PL1 or the second plane PL2 located in the corresponding one of the sub-areas SubA, receiving the any one of the first laser beams LB1 reflected from the corresponding one of the sub-areas SubA of the sensing target TG (i.e. the reflected first laser beam LB1r) by the sensing device 200, i.e. step S103. Then, calculating a depth signal of the corresponding one of the sub-areas SubA of the sensing target TG according to the reflected first laser beams received by the sensing device 200, i.e. step S104.

It is worth mentioning that the first laser beam LB1 provided by the laser scanning module 100 is collimated and only illuminates a sub-area SubA. Therefore, the possibility of receiving multiple reflected laser beam is significantly reduced while receiving the reflected first laser beam LB1r from any one of the first sub-areas by the sensing device 200. That is, the time-of-flight sensing system 10 of present embodiment may avoid multipath interference (MPI) issue, and improve the accuracy of measuring depth signals.

After each of the sub-areas SubA is irradiated by one of the first laser beams LB1 and the depth signal of each sub-areas SubA is calculated, generating a depth map of the sensing target TG according to the depth signals of the sub-areas SubA and the distribution of the sub-areas SubA of the sensing target TG, i.e. step S105. The depth measurement of the sensing target TG using the time-of-flight sensing method is completed herein.

In the following, other embodiments are provided to explain the disclosure in detail, wherein same components will be denoted by the same reference numerals, and the description of the same technical content will be omitted. For the omitted part, please refer to the foregoing embodiment, and the details are not described below. The descriptions regarding the omitted part may be referred to the previous embodiment, and thus will not be repeated herein.

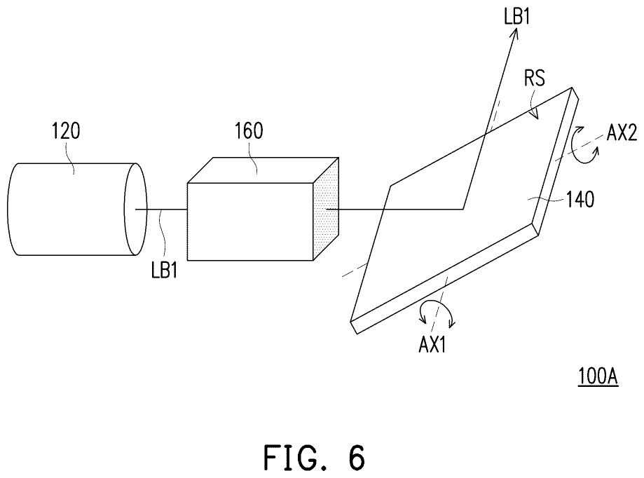

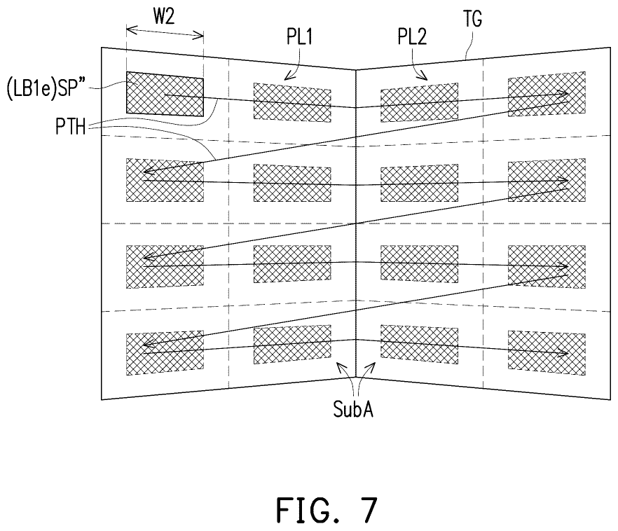

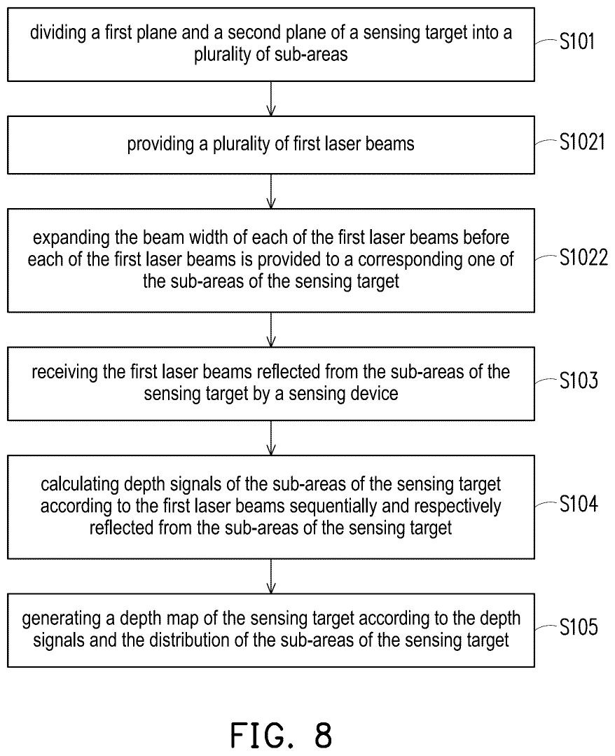

FIG. 6 is a schematic diagram of a laser scanning module according to another embodiment of the disclosure. FIG. 7 is a schematic front-view of the sensing target irradiated by an expanded first laser beam provided by the laser scanning module in FIG. 6. FIG. 8 is a flow chart of a time-of-flight sensing method according to another embodiment of the disclosure.

Referring to FIG. 6 and FIG. 7, the difference between the laser scanning module 100A of present embodiment and the laser scanning module 100 in FIG. 2 lies in the composition of the laser scanning module. In the present embodiment, the laser scanning module 100A further comprises a beam expander 160 configured to expand a beam width of each of the first laser beams LB1 and output an expanded first laser beam LB1e.

More specifically, the time-of-flight sensing method of present embodiment may further comprise expanding the beam width of each of the first laser beams LB1 by using the beam expander 160 before each of the first laser beams LB1 is provided to a corresponding one of the sub-areas SubA of the sensing target TG (i.e. step S1022 in FIG. 8) and after providing a plurality of first laser beams LB1 (i.e. step S1021 in FIG. 8).

For example, the beam spot SP of the first laser beam LB1 provided by the light source 120 and irradiated on each of the sub-areas SubA without beam expansion may have a width W1 along a direction (as illustrated in FIG. 3). The beam spot SP″ of the expanded first laser beam LB1e irradiated on each of the sub-areas SubA with beam expansion may have a width W2 along the direction (as illustrated in FIG. 7), and the width W2 is greater than the width W1.

It is worth mentioning that beam expansion may increase the spot size of the laser beam irradiated on the surface of the sensing target TG so as to reduce the scanning time of the laser scanning module 100 and the processing time of the control circuit 300.

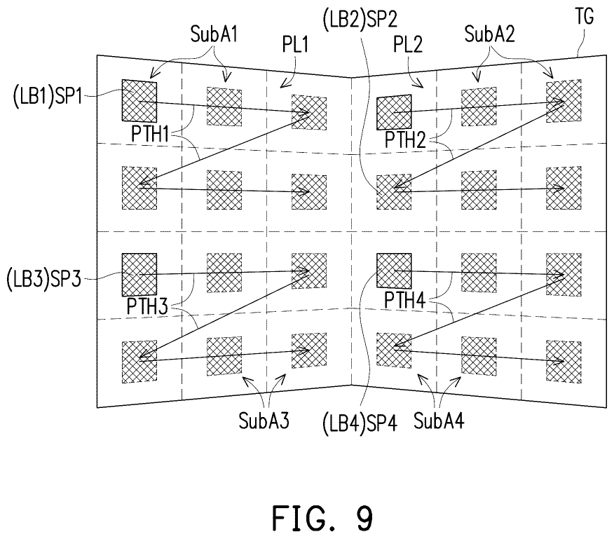

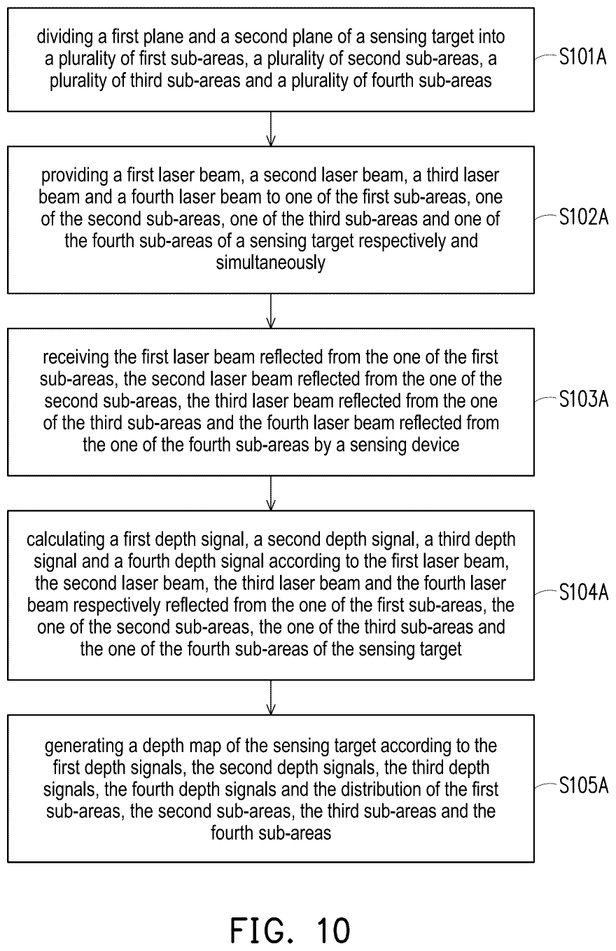

FIG. 9 is a schematic front-view of the sensing target simultaneously irradiated by multiple laser beams. FIG. 10 is a flow chart of a time-of-flight sensing method according to still another embodiment of the disclosure.

Referring to FIG. 9 and FIG. 10, the difference between the time-of-flight sensing method of present embodiment and the time-of-flight sensing method of previous embodiment described in FIG. 3 lies in the laser scanning method.

The following will exemplarily describe the time-of-flight sensing method of present embodiment. Firstly, dividing the first plane PL1 and the second plane PL2 of the sensing target TG into a plurality of first sub-areas SubA1, a plurality of second sub-areas SubA2, a plurality of third sub-areas SubA3 and a plurality of fourth sub-areas SubA4 (i.e. step S101A). In the present embodiment, the plurality of first sub-areas SubA1, the plurality of second sub-areas SubA2, the plurality of third sub-areas SubA3 and the plurality of fourth sub-areas SubA4 do not overlap each other, but the disclosure is not limited thereto.

Then, providing a first laser beam LB1, a second laser beam LB2, a third laser beam LB3 and a fourth laser beam LB4 to one of the first sub-areas SubA1, one of the second sub-areas SubA2, one of the third sub-areas SubA3 and one of the fourth sub-areas SubA4 of the sensing target TG respectively and simultaneously (i.e. step S102A).

In the present embodiment, the plurality of first laser beams LB1 are respectively and sequentially irradiated on the plurality of first sub-areas SubA1 along a scan path PTH1, the plurality of second laser beams LB2 are respectively and sequentially irradiated on the plurality of second sub-areas SubA2 along a scan path PTH2, the plurality of third laser beams LB3 are respectively and sequentially irradiated on the plurality of third sub-areas SubA3 along a scan path PTH3, and the plurality of fourth laser beams LB4 are respectively and sequentially irradiated on the plurality of fourth sub-areas SubA4 along a scan path PTH4.

From another point of view, the first sub-areas SubA1 may be sequentially irradiated by a first laser beam LB1 in a zig-zag manner, the second sub-areas SubA2 may be sequentially irradiated by a second laser beam LB2 in a zig-zag manner, the third sub-areas SubA3 may be sequentially irradiated by a third laser beam LB3 in a zig-zag manner, and the fourth sub-areas SubA4 may be sequentially irradiated by a fourth laser beam LB4 in a zig-zag manner, but the disclosure is not limited thereto.

It should be noted that the emission of each of the first laser beams LB1 is synchronized with the emission of one of the second laser beams LB2, the emission of one of the third laser beams LB3 and the emission of one of the fourth laser beams LB4. More specifically, the scanning of the first laser beam LB1 in the first sub-areas SubA1, the scanning of the second laser beam LB2 in the second sub-areas SubA2, the scanning of the third laser beam LB3 in the third sub-areas SubA3 and the scanning of the fourth laser beam LB4 in the fourth sub-areas SubA4 are synchronized with each other (as illustrated in FIG. 9). Therefore, the scanning time of present embodiment may further be reduced.

On the other hand, the beam spot SP1 of the first laser beam LB1, the beam spot SP2 of the second laser beam LB2, the beam spot SP3 of the third laser beam LB3 and the beam spot SP4 of the fourth laser beam LB4 irradiated on the surface of the sensing target TG may have the same spot size, but the disclosure is not limited thereto.

After the first laser beam LB1, the second laser beam LB2, the third laser beam LB3 and the fourth laser beam LB4 are reflected from the surface the sensing target TG, receiving the first laser beam LB1 reflected from one of the first sub-areas SubA1, the second laser beam LB2 reflected from one of the second sub-areas SubA2, the third laser beam LB3 reflected from one of the third sub-areas SubA3 and the fourth laser beam LB4 reflected from one of the fourth sub-areas SubA4 by the sensing device 200 (i.e. step S103A). Then, calculating a first depth signal, a second depth signal, a third depth signal and a fourth depth signal according to the first laser beam LB1, the second laser beam LB2, the third laser beam LB3 and the fourth laser beam LB4 respectively reflected from the one of the first sub-areas SubA1, the one of the second sub-areas SubA2, the one of the third sub-areas SubA3 and the one of the fourth sub-areas SubA4 of the sensing target TG (i.e. step S104A).

It should be noted that the first depth signal of each of the first sub-areas SubA1, the second depth signal of each of the second sub-areas SubA2, the third depth signal of each of the third sub-areas SubA3 and the fourth depth signal of each of the fourth sub-areas SubA4 can be obtained by repeating the step S102A, the step S103A and the step S104A.

After the first depth signal of each first sub-area SubA1, the second depth signal of each second sub-area SubA2, the third depth signal of each third sub-area SubA3 and the fourth depth signal of each fourth sub-area SubA4 are calculated, generating a depth map of the sensing target TG according to the first depth signals of the first sub-areas SubA1, the second depth signals of the second sub-areas SubA2, the third depth signals of the third sub-areas SubA3 and the fourth depth signals of the fourth sub-areas SubA4 and the distribution of the first sub-areas SubA1, the second sub-areas SubA2, the third sub-areas SubA3 and the fourth sub-areas SubA4 of the sensing target TG (i.e. step S105A). The depth measurement of the sensing target TG using the time-of-flight sensing method of present embodiment is completed herein.

In summary, in the time-of-flight sensing system and the time-of-flight sensing method according to an embodiment of the disclosure, a laser scanning module is adopted to provide a plurality of first laser beams. The first laser beams are sequentially and respectively transmitted to a plurality of first sub-areas of a sensing target. Since the laser scanning module is provided with high directivity, the possibility of receiving multiple reflected laser beam is significantly reduced when the sensing device is receiving the first laser beam reflected from one of the first sub-areas. Such that, the signal-to-noise ratio of the received signal may be improved and a more accurate depth signal may be provided by the time-of-flight sensing system.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A time-of-flight sensing system, comprising:
a laser scanning module, configured to sequentially and respectively provide a plurality of first laser beams to a plurality of first sub-areas of a sensing target;
a sensing device, configured to receive the first laser beams respectively reflected from the first sub-areas of the sensing target; and
a control circuit, electrically coupled to the laser scanning module and the sensing device, and configured to calculate first depth signals of the first sub-areas of the sensing target according to the first laser beams sequentially and respectively reflected from the first sub-areas of the sensing target and received by the sensing device.

2. The time-of-flight sensing system as claimed in claim 1, wherein the first laser beams are modulated continuous-waves.

3. The time-of-flight sensing system as claimed in claim 1, wherein the laser scanning module comprises a scanning mirror.

4. The time-of-flight sensing system as claimed in claim 1, wherein the laser scanning module comprises a beam expander configured to expand a beam width of each of the first laser beams.

5. The time-of-flight sensing system as claimed in claim 1, wherein the control circuit is also configured to generate a depth map of the sensing target according to the first depth signals and a distribution of the first sub-areas of the sensing target.

6. The time-of-flight sensing system as claimed in claim 1, wherein the laser scanning module is also configured to sequentially and respectively provide a plurality of second laser beams to a plurality of second sub-areas of the sensing target, the second sub-areas do not overlap the first sub-areas, the sensing device is also configured to receive the second laser beams reflected from the second sub-areas of the sensing target, and the control circuit is also configured to calculate second depth signals of the second sub-areas of the sensing target according to the second laser beams reflected from the second sub-areas of the sensing target and received by the sensing device.

7. The time-of-flight sensing system as claimed in claim 6, wherein the emission of each of the first laser beams is synchronized with the emission of one of the second laser beams.

8. The time-of-flight sensing system as claimed in claim 6, wherein the control circuit is also configured to generate a depth map of the sensing target according to the first depth signals, the second depth signals and a distribution of the first sub-areas and the second sub-areas of the sensing target.

9. The time-of-flight sensing system as claimed in claim 1, wherein the sensing target includes a first plane and a second plane facing each other and intersecting each other, and the control circuit is also configured to divide the first plane and the second plane into the plurality of first sub-areas.

10. A time-of-flight sensing method, comprising:
providing a plurality of first laser beams to a plurality of first sub-areas of a sensing target sequentially and respectively;
receiving the first laser beams respectively reflected from the first sub-areas of the sensing target by a sensing device; and
calculating first depth signals of the first sub-areas of the sensing target according to the first laser beams sequentially and respectively reflected from the first sub-areas of the sensing target and received by the sensing device.

11. The time-of-flight sensing method as claimed in claim 10, further comprising:
providing a plurality of second laser beams to a plurality of second sub-areas of the sensing target sequentially and respectively, wherein the second sub-areas do not overlap the first sub-areas;
receiving the second laser beams reflected from the second sub-areas of the sensing target by the sensing device; and
calculating second depth signals of the second sub-areas of the sensing target according to the second laser beams sequentially and respectively reflected from the second sub-areas of the sensing target and received by the sensing device.

12. The time-of-flight sensing method as claimed in claim 11, wherein the provision of the first laser beams is synchronized with the provision of the second laser beams.

13. The time-of-flight sensing method as claimed in claim 11, further comprising:
generating a depth map of the sensing target according to the first depth signals, the second depth signals and a distribution of the first sub-areas and the second sub-areas of the sensing target.

14. The time-of-flight sensing method as claimed in claim 10, further comprising:
expanding a beam width of each of the first laser beams before each of the first laser beams is provided to a corresponding one of the first sub-areas of the sensing target.

15. The time-of-flight sensing method as claimed in claim 10, further comprising:
generating a depth map of the sensing target according to the first depth signals and a distribution of the first sub-areas of the sensing target.

16. The time-of-flight sensing method as claimed in claim 10, wherein the sensing target includes a first plane and a second plane facing each other and intersecting each other, the time-of-flight sensing method further comprises:
dividing the first plane and the second plane into the plurality of first sub-areas.
